(19) United States
(12) Patent Application Publication
(10) Pub. No.: US 2006/0281626 A1
(43) Pub. Date: Dec. 14, 2006

(54) Method for manufacturing ceramic structure and the ceramic structure

(75) Inventor: Kyoko Makino, Nagoya-city (JP)

Correspondence Address: OLIFF & BERRIDGE, PLC, P.O. BOX 19928, ALEXANDRIA, VA, 22320, US

(73) Assignee: NGK INSULATORS, LTD., Nagoya-city (JP)

(21) Appl. No.: 11/446,186

(22) Filed: Jun. 5, 2006

(30) Foreign Application Priority Data
Jun. 14, 2005 (JP) 2005-173565

(51) Int. Cl. C04B 35/00

(52) U.S. Cl. 501/127; 501/134; 501/153; 264/122

(57) ABSTRACT

An aluminum titanate-based ceramic honeycomb structure is manufactured by subjecting a starting raw material of a mixed composition powder containing 45% by mass or more of an aluminum source in terms of Al₂O₃, where 5% by mass or more of boehmite is contained in the aluminum source, and 30% by mass or more of TiO₂ to forming, drying, and firing at 1350 to 1500° C. There are provided a method for manufacturing a ceramic structure and the ceramic structure, the method being capable of manufacturing a ceramic structure having a low thermal expansion coefficient and excellent thermal shock resistance and size accuracy by low-temperature firing at 1350 to 1500° C. without spoiling original properties of aluminum titanate (AT).

### BACKGROUND OF THE INVENTION AND RELATED ART

The present invention relates to a method for manufacturing a ceramic structure and to the ceramic structure.

Various improvements are added to an AT (aluminum titanate) ceramic material with components, additives, or the like. Specifically, a technique has been reported in which an AT ceramic material containing at least two kinds selected from SiO₂, Fe₂O₃, Al₂O₃, TiO₂, MgO, CaO, and the like, has a thermal expansion coefficient of 0.1×10⁻⁶ to 0.8×10⁻⁶/° C. at 30 to 800° C. (see JP-A-8-290963).

In particular, a head port liner, an exhaust manifold liner, a catalyst converter, and an exhaust gas filter for automobiles are disposed near the engine and continuously exposed to thermal shocks. Therefore, an aluminum titanate ceramic structure is required to have sufficient thermal shock resistance. Resultantly high firing temperature is required for it, but reduction in thermal expansion in low-temperature firing at 1350 to 1500° C. has not always been sufficient.

The present invention has been developed in view of such problems in the conventional technology, and an object thereof is to provide a method for manufacturing a ceramic structure, the method being capable of manufacturing a ceramic structure having a low thermal expansion coefficient and excellent thermal shock resistance and size accuracy by low-temperature firing at 1350 to 1500° C. without spoiling original properties of aluminum titanate (AT) and to provide the ceramic structure.

### SUMMARY OF THE INVENTION

To achieve the above-described object, according to the present invention, there are provided the following method for manufacturing a ceramic structure and the ceramic structure.

[1] A method for manufacturing a ceramic structure, comprising the steps of:

preparing as a starting raw material a mixed composition of powders containing 45% by mass or more of an aluminum source in terms of Al₂O₃, where 5% by mass or more of boehmite is contained in the aluminum source, and 30% by mass or more of TiO₂, and

forming the mixed composition of powders to give a formed body and drying the formed body, followed by firing the formed body at 1350 to 1500° C. to obtain an aluminum titanate-based ceramic structure.

[2] The method for manufacturing a ceramic structure according to [1], wherein the Boehmite has a BET specific surface area of 100 m²/g or more.

[3] The method for manufacturing a ceramic structure according to [1] or [2], wherein the aluminum source further contains alumina and/or aluminum hydroxide.

[4] The method for manufacturing a ceramic structure according to any one of [1] to [3], wherein the ceramic structure is constituted by 65% by mass or more of an aluminum titanate crystal phase.

[5] The method for manufacturing a ceramic structure according to any one of [1] to [4], wherein the ceramic structure has a thermal expansion coefficient of 1.5×10⁻⁶/° C. or less at 40 to 800° C.

[6] A ceramic structure manufactured in a method for manufacturing a ceramic structure according to any one of [1] to [5].

### DETAILED DESCRIPTION OF THE INVENTION

According to the method for manufacturing a ceramic structure of the present invention, there is provided a ceramic structure having a low thermal expansion coefficient and excellent thermal shock resistance and size accuracy by low-temperature firing without spoiling original properties of aluminum titanate (AT).

A method for manufacturing a ceramic structure of the present invention will hereinbelow be described in detail on the basis of a specific embodiment. However, the present invention should not be construed with limiting to this, and various changes, modifications, and improvements can be given on the basis of knowledge of those skilled in the art as long as they do not deviate from the scope of the present invention.

According to the method for manufacturing a ceramic structure of the present invention, there is prepared, as a starting raw material, a mixed composition of powders containing 45% by mass or more of an aluminum source in terms of Al₂O₃, where 5% by mass or more of boehmite is contained in the aluminum source, and 30% by mass or more of TiO₂, the mixed composition of powders is formed to give a formed body, and the formed body is dried, followed by firing the formed body at 1350 to 1500° C. to obtain an aluminum titanate-based ceramic structure.

That is, according to the method for manufacturing a ceramic structure of the present invention, there is provided a method for manufacturing an aluminum titanate-based ceramic structure obtained by forming slurry containing AT-forming raw material, and drying and firing the formed body, where as an aluminum source in the AT-forming raw material (aluminum titanate-forming raw material) a boehmite is used.

Here, the main characteristic of the AT-forming raw material used in the present invention is that it contains 45 to 58% by mass of an aluminum source in terms of Al₂O₃ where 5 to 90% by mass of boehmite is contained in the aluminum source. This imparts characteristics such as a low thermal expansion coefficient and excellent thermal shock resistance to a ceramic structure manufactured in the present invention.

At this time, the boehmite contained in the AT-forming raw material has a BET specific surface area of preferably 80 to 500 m²/g , more preferably 100 to 500 m²/g , furthermore preferably 150 to 400 m²/g. The percentage of the aluminum source is preferably 45 to 58% by mass in terms of the oxide, and more preferably 50 to 55% by mass.

In the AT-forming raw material used in the present invention, boehmite (Al₂O₃·H₂O) having a mean particle diameter of 1 μm or less is contained at a ratio of 5 to 90% by mass with respect to the aluminum source in the AT-forming raw material. When boehmite in a fine particle form with a mean particle diameter of 1 μm or less is used at a predetermined ratio as at least a part of the aluminum source, the AT-forming reaction is accelerated, and therefore the thermal expansion coefficient is lowered. When the average particle diameter is above 1 μm, the thermal expansion coefficient of the ceramic structure obtained cannot be lowered. When the ratio of boehmite having a mean particle diameter of 1 μm or less to the AT-forming raw material is less than 5% by mass, the thermal shock resistance of the ceramic structure obtained cannot be enhanced sufficiently from the similar point of view. On the other hand, when the ratio is above 90% by mass, shrinkage upon drying and firing is increased, which makes it difficult to manufacture the ceramic structure having the aimed structure with high size accuracy.

As the boehmite contained in the aluminum source, either boehmite or pseudoboehmite may be used. The boehmite has a mean particle diameter of preferably 1 μm or less, and more preferably 0.5 μm or less. The percentage of the boehmite contained in the aluminum source is preferably 5 to 90% by mass, and more preferably 5 to 30% by mass with respect to AT-forming raw material. Incidentally, raising the ratio of boehmite to the aluminum source is advantageous because the thermal expansion coefficient of the ceramic structure obtained can be lowered and preferable because further the firing temperature can be lowered.

A “mean particle diameter” in the present specification means a value of 50% particle diameter measured with a laser diffraction/scattering type particle diameter measuring apparatus (for example, LA-910 (trade name) produced by Horiba, Ltd.) on the principle of a light scattering method. Incidentally, the measurement is performed in a state that a raw material is completely diffused in water.

Next, a method for manufacturing a ceramic structure of the present invention will be described in more detail by each step. First, the AT-forming raw material is obtained by adding a silica source material and a magnesia source material to an aluminum source material and a titania source material, which become an aluminum source and a titania source, respectively, in the AT composition. A dispersion medium such as water is added to the AT-forming raw material obtained above with mixing and kneading to obtain clay. The “AT-forming raw material” means the material prepared in such a manner that the composition after firing becomes the theoretical composition (Al₂TiO₅) of aluminum titanate.

Though a composition of the AT-forming raw material used in the present invention is not particularly limited, the main component is 45 to 58% by mass of an aluminum source in terms of Al₂O₃, where 5 to 90% by mass of boehmite is contained in the aluminum source. and 30 to 45% by mass of TiO₂.

In the present invention, a composition of the above AT-forming raw material can be made almost the same as a composition of a ceramic structure obtained after firing by adjusting the composition of the above AT-forming raw material to be within the above ranges. On the other hand, when each of the composition is out of the above range, it is not preferable because the original properties of aluminum titanate may be lost, imparting high porosity by increasing pore sizes cannot be realized, and thermal shock resistance and size accuracy of the ceramic structure obtained may be influenced.

In a raw material having the above composition, it is important to use boehmite as an aluminum source in order to exhibit an effect of the present invention. There is no particular limitation on the TiO₂ source, and examples of the TiO₂ source include rutile type and anatase type. In addition, there is no particular limitation on the SiO₂ source, silica, a compound oxide containing silica or materials which are converted to silica by firing, can be used as the SiO₂ source. Specifically, silica glass, kaolin, mullite, quartz, or the like, may be used. Further, there is no particular limitation on the MgO source, magnesia, a compound oxide containing magnesia or a materials which are converted to magnesia by firing, can be used as the MgO source. Specifically, talc, magnesite, or the like, may be used, and talc is more preferably used.

As the dispersion medium added to the AT-forming raw material water or a mixed solvent of water and an organic solvent such as alcohol can be used. In particular, water can suitably be used. When the dispersion medium is mixed and kneaded with the AT-forming raw material, additives such as a pore former, an organic binder, a dispersant, and the like, may further be added.

As the pore former, carbon such as graphite, wheat flour, starch, phenol resin, polymethyl methacrylate, polyethylene, polyethylene terephthalate, water-absorbable polymer, a microcapsule of an organic resin such as acrylic resin, or the like, may suitably be used.

As the organic binder, hydroxypropylmethyl cellulose, methyl cellulose, hydroxyethyl cellulose, carboxylmethyl cellulose, polyvinyl alcohol, or the like, may suitably be used. As the dispersant, a substance having a surface activating effect, for example, ethylene glycol, dextrin, fatty acid soap, and polyalcohol may suitably be used.

Incidentally, the AT-forming raw material and the dispersion medium may be mixed and kneaded according to a known mixing and kneading method. However, it is preferable to mix them using a mixer having excellent starring and dispersing force and being capable of rotating a stirring blade at a high speed of 500 rpm or more (preferably 1000 rpm or more) in a method of stirring with shearing force. By such a mixing method, an aggregate of fine particles contained in each raw material particle, which causes defects of the resultant ceramic structure, can be ground and vanished.

Finally, by firing the obtained ceramic dried body, a ceramic structure can be obtained. Since firing conditions (temperature and time) depends on kinds of raw material particles constituting the ceramic formed body, they may suitably set according to these kinds. For example, it is preferable to fire the ceramic dried body at 1300 to 1550° C. for 3 to 10 hours. When the firing conditions (temperature and time) are lower than the above ranges, crystallization of aluminum titanate (AT) in the framework raw material particles tends to be insufficient. On the other hand, when they are above the ranges, aluminum titanate (AT) formed tends to melt.

Incidentally, before firing it is preferable to perform the combustion operation (calcination) for removing organic substances (pore former, organic binder, dispersant, etc.) in the ceramic dried body because the removal of the organic substances can be accelerated. The combustion temperature of the organic binder is about 200° C., and the combustion temperature of the pore former is about 300 to 1000° C. Therefore, the calcination temperature may be about 200 to 1000° C. The calcination time is not particularly limited, and it is generally about 10 to 100 hours.

In addition, as to the ceramic structure obtained, it is preferable that the crystal phase of the ceramic structure is constituted by 65 to 95% by mass (preferably 70 to 95% by mass) of aluminum titanate.

Further, it is preferable that the ceramic structure of the present invention has a thermal expansion coefficient of 0.10×10⁻⁶ to 1.5×10⁻⁶/° C. (more preferably 0.1×10⁻⁶ to 1.0×10⁻⁶/° C.). Because in view of all ceramic structures and shapes, in this range the ceramic structure has excellent thermal shock resistance. On the other hand, when the thermal expansion coefficient is above 1.5×10⁻⁶/° C., sufficient thermal shock resistance cannot be obtained in the case of a structure having high porosity and volume. Therefore, it is preferable that the ceramic structure obtained has a thermal expansion coefficient of 0.1×10⁻⁶ to 1.0×10⁻⁶/° C. from the viewpoint of imparting superior thermal shock resistance.

From the above, a ceramic structure of the present invention can suitably be used as, for example, a head port liner, an exhaust manifold liner, a catalyst converter, or an exhaust gas filter for automobiles.

### EXAMPLE

The present invention will hereinbelow be described more specifically with examples. However, present invention is by no means limited to these examples.

### Example 1 and Example 2

As shown in Table 1, the aluminum titanate-forming raw material (AT-forming raw material) was prepared by mixing and kneading α-alumina (mean particle diameter: 5.0 μm, BET specific surface area: 0.8 m²/g), boehmite (mean particle diameter: 0.1 μm, BET specific surface area: 163 m²/g), titanium dioxide (mean particle diameter: 0.2 μm), and highly purified kaolin (mean particle diameter: 3 μm) together. To 100 parts by mass of the prepared AT-forming raw material, 1.5 parts by mass of an organic binder (methyl cellulose, hydroxypropylmethyl cellulose) was added and mixed, and the mixture was subjected to vacuum degassing. The resultant mixture subjected to vacuum degassing was subjected to slip casting with a plaster mold to obtain a formed body. The formed body was fired at firing temperature shown in Table 2 under normal pressure to obtain an AT fired body. Each AT fired body obtained was measured for thermal expansion coefficient. The results are shown in Table 2.

### Comparative Example

As shown in Table 1, the aluminum titanate-forming raw material (AT-forming raw material) was prepared by mixing α-alumina (mean particle size: 5.0 μm, BET specific surface area: 0.8 m²/g), titanium dioxide (mean particle size: 0.2 μm), and highly purified kaolin (mean particle size: 3 μm) together. To 100 parts by mass of the prepared AT-forming raw material, 1.5 parts by mass of an organic binder (methyl cellulose, hydroxypropylmethyl cellulose) was added and mixed, and the mixture was subjected to vacuum degassing. The resultant mixture subjected to vacuum degassing was subjected to slip casting with a plaster mold to obtain a formed body. The formed body was fired at firing temperature shown in Table 2 under normal pressure to obtain an AT fired body. The AT fired body was measured for thermal expansion coefficient. The result is shown in Table 2.

TABLE 1

| | | | | Comp. |
|---|---|---|---|---|
| | | Example 1 | Example 2 | Ex. |
| Boehmite ratio in | | 50 | 50 | 0 |
| aluminum source | | | | |
| (mass %) | | | | |
| Composition | Al₂O₃ | 54.2 | 54.2 | 54.2 |
| (mass %) | TiO₂ | 42.5 | 42.5 | 42.5 |
| | SiO₂ | 3.3 | 3.3 | 3.3 |
| | Fe₂O₃ | <0.05 | <0.05 | <0.05 |
| | MgO | <0.04 | <0.04 | <0.04 |
| | CaO + NaO + K₂O | <0.05 | <0.05 | <0.05 |

TABLE 2

| | | | | Comp. |
|---|---|---|---|---|
| | | Example 1 | Example 2 | Ex. |
| Firing | Firing | 1500 | 1400 | 1500 |
| condition | temperature | | | |
| | (° C.) | | | |
| | Time (hr) | 5 | 5 | 5 |
| Thermal | ×10⁻⁶° C. | 0.8 | 1.2 | 1.8 |
| expansion | | | | |
| coefficient | | | | |

### Discussion: Examples 1 and 2, and Comparative Example

As shown in Table 2, in Examples 1 and 2, the thermal expansion coefficients could be reduced in comparison with the Comparative Example without spoiling original properties of aluminum titanate by using boehmite having a large BET specific surface area as an aluminum source. Even at lower firing temperature, a low thermal expansion coefficient could be maintained. (In addition, in Examples 1 and 2, a ceramic structure having small thermal coefficient could be manufactured in comparison with Comparative Example.)

A method for manufacturing a ceramic structure of the present invention can manufacture a ceramic structure having a low thermal expansion coefficient and excellent thermal shock resistance and size accuracy without spoiling original properties of aluminum titanate (AT). A ceramic structure obtained by this can suitably be used as a head port liner, an exhaust manifold liner, a catalyst converter, or an exhaust gas filter for automobiles.

What is claimed is:

1. A method for manufacturing a ceramic structure, comprising the steps of:
preparing as a starting raw material a mixed composition of powders containing 45% by mass or more of an aluminum source in terms of Al₂O₃, where 5% by mass or more of boehmite is contained in the aluminum source, and 30% by mass or more of TiO₂, and
forming the mixed composition of powders to give a formed body and drying the formed body, followed by firing the formed body at 1350 to 1500° C. to obtain an aluminum titanate-based ceramic structure.

2. The method for manufacturing a ceramic structure according to claim 1, wherein the boehmite has a BET specific surface area of 100 m²/g or more.

3. The method for manufacturing a ceramic structure according to claim 1, wherein the aluminum source further contains alumina and/or aluminum hydroxide.

4. The method for manufacturing a ceramic structure according to claim 1, wherein the ceramic structure is constituted by 65% by mass or more of an aluminum titanate crystal phase.

5. The method for manufacturing a ceramic structure according to claim 1, wherein the ceramic structure has a thermal expansion coefficient of 1.5×10 ⁻⁶/° C. or less at 40 to 800° C.

6. A ceramic structure manufactured in a method for manufacturing a ceramic structure according to claim 1.
